(19) United States
(12) Patent Application Publication
(10) Pub. No.: US 2007/0002119 A1
(43) Pub. Date: Jan. 4, 2007

(54) Digital workflow processes

(76) Inventor: Timothy J. Abrott, Normandy Park, WA (US)

Correspondence Address: WEYERHAEUSER COMPANY;INTELLECTUAL PROPERTY DEPT., CH 1J27, P.O. BOX 9777, FEDERAL WAY, WA, 98063, US

(21) Appl. No.: 11/171,045

(22) Filed: Jun. 30, 2005

(51) Int. Cl. B41J 2/01

(52) U.S. Cl. 347/105

(57) ABSTRACT

Embodiments of the present invention include a digital workflow process that is suitable for creating a product having a desired appearance according to a customer's instructions. Embodiments of the digital workflow process includes a digital prepress and printing workflow process for generating, manipulating, and processing image data and for printing such image data on a selected substrate. Embodiments of the present invention also include processes for creating an artwork file that designates opaque or transparent white inks and transparent color inks to be printed. Several embodiments also incorporate a metallic layer into the design for achieving specific design objectives.

### FIELD OF THE INVENTION

Embodiments of the present invention generally relate to digital workflow processes for the graphics and printing industry, and in particular, to digital workflow processes for use in the packaging industry, that utilize metallic layers, white inks, transparent color inks, or combinations thereof, to achieve a desire result.

### BACKGROUND OF THE INVENTION

Virtually all consumer products are sold in packages, such as cardboard cartons, boxes, and other types containers. A package has two very distinguishing features: a structural design and a graphical design. The structural design of a package is defined by the package's structural features, such as the dimensions, geometric shape and material of the package. The graphical design of a package is defined by the colors, artwork and other images applied thereto. The graphical design preferably identifies the packaged product in a manner which is aesthetically appealing to potential consumers.

A package is typically formed from a sheet of corrugated board, carton board, or other work material upon which a graphical design is applied. The applied graphical design may be somewhat simple, such as vector based images, are more complex, such as raster based images. The graphical design may be applied by many known processes. For example, a vinyl sheet having a design may be laminated to the package or the package may be printed lithographically, while still others may be printed with flexographic or rotogravure techniques.

### SUMMARY OF THE INVENTION

In accordance with aspects of the present invention, a method for printing an image on a substrate is provided. The image has one or more ink layers when printed. The method comprises obtaining a substrate having at least one surface on which the image will be applied; digitally printing a white ink layer over a predetermined portion of the substrate surface; and digitally printing one or more layers of ink over a portion of the printed white layer and/or the substrate surface, thereby generating the image on the substrate.

In accordance with another aspect of the present invention, a method of generating print data in a digital computer system is provided. The method comprises generating an artwork file within an image processing program. The artwork file comprising at least one image formed by one or more inks when printed on a substrate. The method further includes creating a white opaque ink layer as a discrete layer within the artwork file, the white ink layer designated to be printed on the substrate via an ink jet printer using white ink before the at least one image is to be printed.

In accordance with another aspect of the present invention, a computer readable medium having computer-executable instructions for printing an image on a substrate is provided. The computer readable medium comprises a first component for instructing a white ink layer to be digitally printed on a surface of a substrate in select locations, and a second component for instructing at least one other ink layer to be digitally printed on the surface of the substrate or the white ink layer, the one other ink layer creating the image on the substrate when printed.

### BRIEF DESCRIPTION OF THE DRAWINGS

The foregoing aspects and many of the attendant advantages of this invention will become more readily appreciated by reference to the following detailed description, when taken in conjunction with the accompanying drawings, wherein:

FIG. 1 is a flow diagram depicting one exemplary embodiment of a digital workflow process for creating a product having a desired appearance formed in accordance with aspects of the present invention;

FIG. 2 is an illustrative subprocess for generating an artwork file to be printed on a product according to the customer's instructions;

FIG. 3 is an illustrative subprocess for processing an artwork file to be printed on a product according to the customer's instructions; and

FIG. 4 is a block diagram of one suitable computer system in which embodiments of the present invention may be implemented in accordance with aspects of the present invention.

### DETAILED DESCRIPTION OF THE PREFERRED EMBODIMENT

Embodiments of the present invention will now be described with reference to the accompanying drawings where like numerals correspond to like elements. The following description provides examples of a digital prepress and printing workflow process for generating and processing image data and for printing such image data on a selected substrate. The following examples generally describe processes for creating an artwork file that designates either opaque or transparent white inks and transparent color inks to be printed. Several embodiments also incorporate a metallic layer into the design for achieving specific design objectives. However, it should be apparent that these examples are only illustrative in nature and should not be considered as limiting the embodiments of the present invention, as claimed.

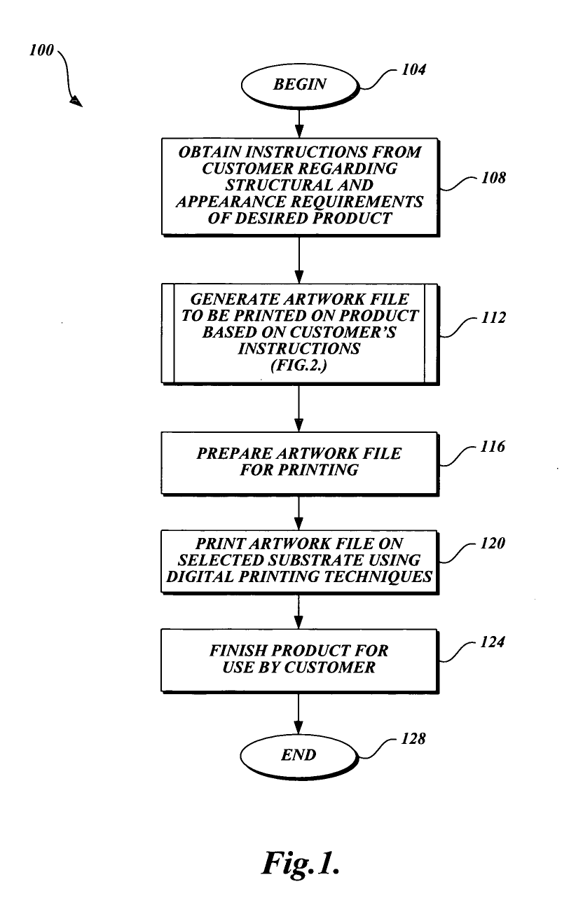

Referring now to FIG. 1, there is shown a flow diagram depicting one exemplary digital workflow process, generally designated 100, which is formed in accordance with aspects of the present invention. The digital workflow process 100 is suitable for creating a product having a desired appearance according to a customer's instructions. It should be appreciated that the digital workflow process 100 works well with both process and non-process color formats. For example, the digital workflow process 100 works well with CMY, CYMK, or CMYabc color formats, as well as Duotone, Tritone, Quadtone color formats, just to name a few. The process 100 may also utilize black and white images and may print black and white images on the selected substrate.

Generally described, the process 100 begins at block 104 and proceeds to block 108 where a graphic designer obtains instructions from a customer desiring a custom product with graphical images to be printed thereon, such as a package, packaging display, shipping container, or the like. The instructions obtained from the customer include the structural requirements for the product and the graphical requirements for the artwork to appear on the product. For example, the customer may have specific images, logos, and/or text in mind to be used, or the customer may have a general concept in mind for the graphic designer to further develop. The instructions may specify the ink type, colors, substrates, etc. to be used.

As will be described in more detail below, in one embodiment of the present invention, the instructions may call for at least one image to be printed with standard four (4) process color inks (C, M, Y, and K) on a substrate, a portion of which has a metallized or metallic outer layer. The metallic or metallized layer provides various reflective effects to the image that overprints the layer. In other embodiments, the instructions may call for at least one image to be printed on a substrate, such as containerboard, with standard (3) process color inks (C, M, and Y,), along with a first spot color, such as white ink, and a second spot color, such as a metallic ink. The metallic appearance of the metallized or metallic layer can vary from highly reflective to dull, monochromic (single color) to rainbow (multi-color) reflective, uniform to patterned, organized to random (patterns), etc.

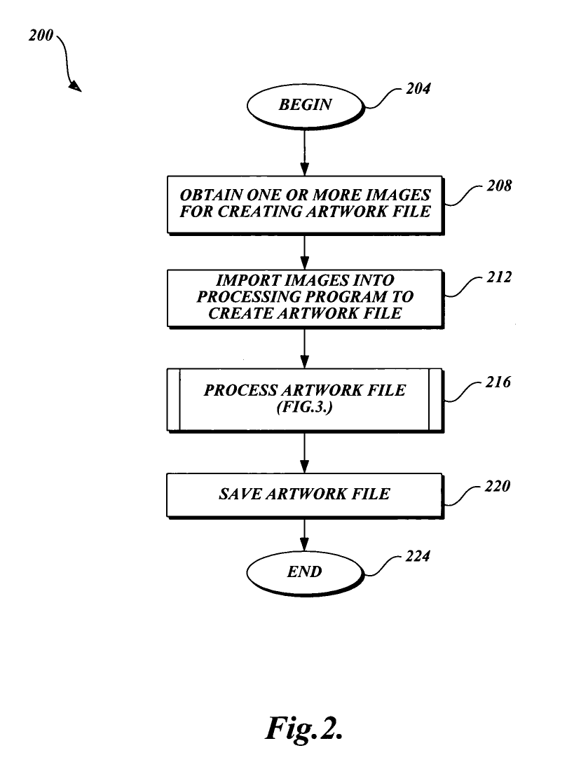

After the instructions from the customer are obtained at block 108, the process proceeds to block 112. At block 112, the graphic designer creates a digital artwork file that will be digitally printed on the product based on the customer's instructions. As will be described in more detail below with reference to FIG. 2, the digital artwork file is generated in a conventional computer system using conventional desktop publishing software programs, such as Adobe Photoshop®, Adobe Illustrator®, Adobe PageMaker®, QuarkXPress™, etc., or combinations thereof, and may be stored on any conventional computer readable media, some of which are described in detail below. The term desktop publishing program is used herein to include all programs, such as image processing programs, image creation programs, and page creation programs, that are employed, for example, in the desktop publishing, graphic arts, or engineering drawing industries.

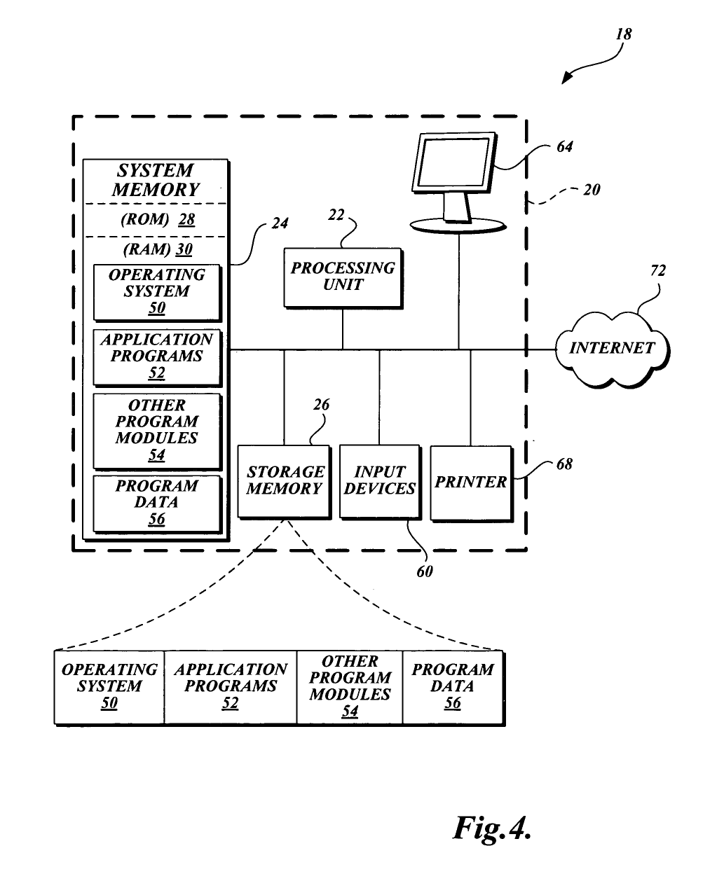

One suitable computer system 18 in which embodiments of the present invention may be implemented is illustrated as a block diagram in FIG. 4. Although not required, aspects of the present invention will be described in the general context of computer-executable instructions, such as program modules, being executed by a personal computer and stored, for example, on computer readable media, as will be described below. Generally, program modules include routines, programs, objects, components, data structures, etc. that perform particular tasks or implement particular abstract data types.

The conventional computing system 18 includes a general computer 20, including a processing unit 22, a system memory 24, and a storage memory 26 suitable interconnected. The system memory 24 includes read only memory (ROM) 28 and random access memory (RAM) 30, and the storage memory may include hard disk drives for reading from and writing to a hard disk, a magnetic disk drive for reading from or writing to a removable magnetic disk, and an optical disk drive for reading from or writing to a removable optical disk, such as a CD, DVD or other optical media. The storage memory and their associated computer-readable media provide non-volatile storage of computer readable instruction, data structures, program modules and other data for the computer 20. Other types of computer readable media which can store data that is accessible by a computer, such as magnetic cassettes, flash memory cards, digital video disks, Bernoulli cartridges, random access memories (RAMs), read only memories (ROMs), and the like, may also be used in the exemplary computer system.

A number of program modules may be stored on the storage memory 26 or system memory 24, including an operating system 50, one or more application programs 52, including desktop publishing programs, such as Adobe Photoshop®, Adobe Illustrator®, and/or Adobe PageMaker®, other program modules 54, such as color ink jet drivers and/or printing preparation programs, and program data 56. The computing system 18 may further include input devices 60, such as a keyboard, a pointing device, a scanner, or the like, suitable connected through appropriate interfaces, such as serial ports, parallel ports or a universal serial bus (USB). A monitor 64 or other type of display device is also included. In addition to the monitor, the computer system also includes other peripheral output devices, such as a color ink jet printer 68 capable of printing white opaque and white translucent inks, metallic inks, and varnish. One such printer that may be practiced with the present invention is the XenJet 4200, commercially available from Xennia Technology Ltd., Hertfordshire, UK.

Next, the artwork file is prepared for printing at block 116. This may occur at the computer system 18 running the desktop publishing program, a separate printing workstation, a print server, or other known device that is capable of appropriately preparing the artwork file to be printed on a selected digital output device, such as an ink jet printer, via appropriate printing preparation software. This process may involve, for example, converting the file into an appropriate file format, such as a Postscript file, and/or converting the continuous tone image into a bitmap image using conventional half-tone screening techniques. In several embodiments, the artwork file is processed to create, for example, digital ink jet printing instructions, which will apply inks onto the selected substrate, such as a metallic layered or non-metallic layered substrate, in the specified locations and sequences to achieve the specified design appearance of the artwork file.

Once the artwork file is prepared for printing, the prepared artwork file may then be printed on a selected substrate using digital printing techniques, such as ink jet printers, laser jet printers, etc., at block 120. As will be described in more detail below, in several embodiments of the present invention, the selected substrate is preferably one having a surface, at least a portion of which includes a metallic or metallized layer, such as a metallic coating, metallic film, printed metallic ink(s) (applied, for example, using flexographic or printing plate techniques), etc., affixed thereon via any conventional method. Such a substrate is referred herein as a metallic layered substrate. In other embodiments, substrates without a metallic outer layer may be utilized, which may also be referred to herein as a non-metallic layered substrate. In these embodiments, as will be described in detail below, metallic inks may be digitally printed on the non-metallic layered substrate for creating a metallic layer to provide the desired effect.

The substrates that may be utilized by embodiments of the present invention can be any container blank or container suitable for use in the packaging, shipping, storing or displaying industry. Several examples of a substrate that may be practiced with the present invention, including the metallic layered substrate, include but are not limited to containerboard, fiberboard, linerboard, cardboard, paperboard, corrugated board, and styrene. At block 124, the printed substrate may then be finished, such as scored, cut, slotted, folded, glued, etc. in order to complete the product desired by the customer. The process 100 ends at block 128.

Referring now to FIG. 2, an illustrative subprocess 200 for generating an artwork file to be printed on a product according to the customer's instructions will be described in detail. The subprocess 200 begins at block 204 and proceeds to block 208, where one or more composite images that are desired by the customer are obtained. For example, the images may be a natural scene containing complex content, e.g. a photographic image, or may simply be line art or drawn illustrations, such as a company logo. The images may be for example, any conventionally encoded digital image, preferably 8 or 16 bit, in one of many color image formats, such as “RGB” (a 3-color system including red (“R”), green (“G”), and blue (“B”)), “CMY” (a 3-color system including cyan (“C”), magenta (“M”), and yellow (“Y”)), or “CMYK” (a 4-color system including the “CMY” colors and black (“K”)), or in black and white format.

One or more of the images can be transferred as digital images into the computer memory 24 and/or 26 of the computer system 18, an example of which is described with reference to FIG. 4, using any one of numerous means of transferring a document into computer memory. For example, the images may be downloaded from a secondary source, such as the Internet 72, a CD-ROM, DVD-ROM, flash memory or other digital storage means, or a digital camera. Alternatively, one or more of the images may be created in the computer system by using a suitable desktop publishing program, such as Adobe Illustrator® or Macromedia Freehand®, which may be stored in the computer memory. One or more of the images may also be obtained by digitally scanning a printed image using a scanner suitable connected to the computer system as well known in the art. In one example hereinafter described, the images are RGB encoded digital images capable of being viewed on an additive color system using the computer system with a CRT monitor or equivalent display device.

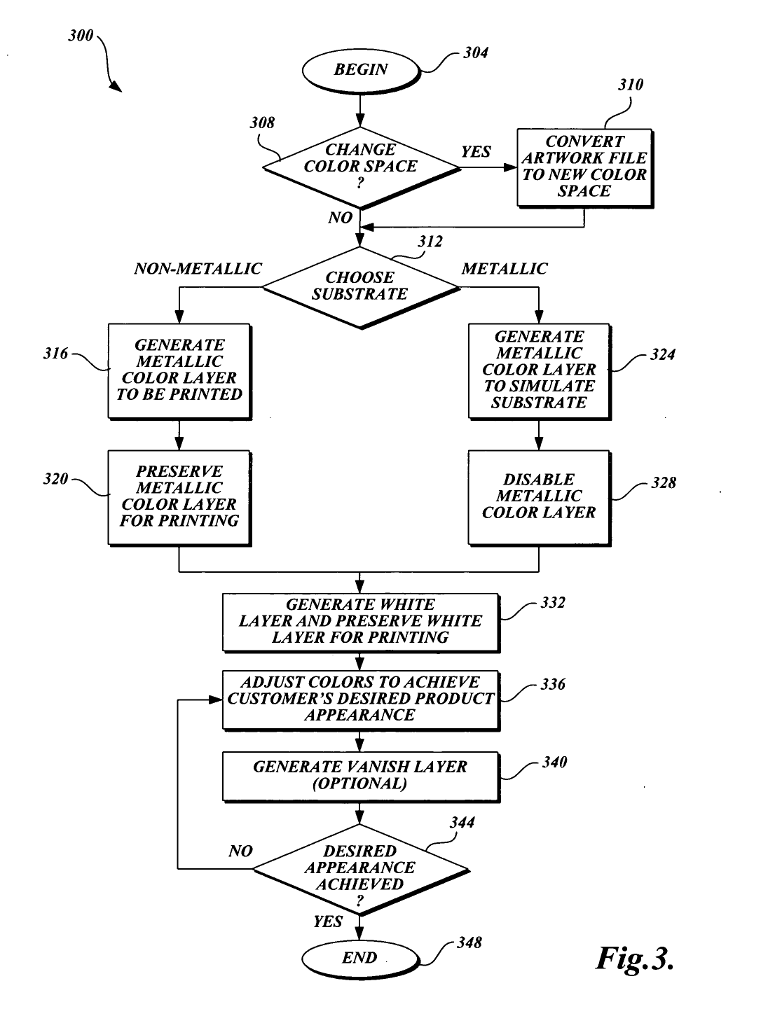

The process 200 then proceeds to block 212, where the image or images may be imported into a newly created file of a desktop publishing software program, such as Adobe Photoshop®, executed on the computer system. The image or composition of more than one image in the newly created file will be hereinafter referred to as the artwork file. The desktop publishing software program, when executed, enables the artwork file to be generated, processed, and stored according to user selected commands. After the images are imported into the newly created file of the desktop publishing program at block 212, thereby creating the artwork file, the artwork file may then be processed using selected user commands at block 216, as will be described in more detail with regard to FIG. 3. The process 200 then proceeds to block 220, where the processed artwork file may be saved in the computer memory for subsequent printing steps or further processing. In several embodiments, the artwork file is saved in TIFF format, although other formats may be practiced with the present invention. The process 200 ends at block 224. It will be appreciated that the saved artwork file contains computer executable instructions, which instruct an image to be printed on a selected substrate via a digital printing device.

Referring now to FIG. 3, an illustrative subprocess 300 for processing an artwork file to be printed on a product according to the customer's instructions will be described in detail. The subprocess 300 begins at block 304 and proceeds to block 308, where a determination is made whether to change the color space of the artwork file. For example, if the designer wishes to work in the additive color space, such as the RGB color space, or one of the subtractive color spaces, such as CMY or CMYK color space, a color conversion may be necessary depending on the color space of the artwork file. In embodiments where the designer wishes to work in, for example, the CMYK color space, but creates the artwork file in, for example, the RGB color space or vice versa, the subprocess proceeds to block 310 where the designer initiates a color space change within the image processing software for converting the color space of the art file to the desired color space.

In embodiments that employ Adobe Photoshop® to process the artwork file, the conversion is sometimes referred to as a mode change. As such, the processing software re-expresses an RGB encoded artwork file in, for example, CMYK units; i.e., it yields a CMYK artwork file and four ink separation positives of the artwork file for the cyan, magenta, yellow, and black inks (C, M, Y, K separation positives, sometimes referred to as C, M, Y, K channels) or re-expresses a CMYK encoded artwork file in RGB units, i.e., it yields a RGB artwork file and three channels of the artwork file for the Red, Green, and Blue inks. It will be appreciated that other suitable software programs may be used to accomplish similar conversions, some examples being Adobe Illustrator®, QuarkXPress™, available from Quark, Inc. Denver Colo.; CorelDraw® and other packages, available from Corel Corp., Ottawa, Ontario; and Paint Shop Pro, a shareware program available on the Internet. In embodiments where the color space of the image file and the designer's preference of the color space are the same, no conversion is necessary, and the subprocess proceeds to block 312.

It will be appreciated that in several embodiments, if desired, the RGB artwork file may be readily converted to a CMY or CMYK artwork file and vice versa using complimentary mapping techniques. Alternatively, the artwork file may be converted to other formats, such as a CIE L*a*b* format, using encoding techniques such as look-up table mapping. Complementary mapping generally refers to the color(s) a filter of a given color absorbs. For example, since a red filter passes red (R) light but blocks green and blue light, its complement; i.e., 1-R, yields the amount of non-red light, which is essentially green and blue. Cyan light is a mixture of green and blue light. Look-up table mapping generally refers to the relationship between RGB and CIE L*a*b* color. Other color formats may also be used with embodiments of the present invention. For example, an RGB encoded artwork file may be converted into a color format having five or more inks; e.g., to CMYKabc using International Color Consortium (ICC) profiles or other empirical or model-based conversion methods with CMYK process inks and ink colors “a”, “b”, “c”; or an RGB encoded image may be converted into traditional two (Duotone), three (Tritone) or four-color (Quadtone) printing using commercial or other available conversion methods.

In accordance with aspects of the present invention, the customer's instructions may have indicated a preference for the appearance of metallic colored inks on a non-metallic surface. This appearance may be achieved in several different ways, two of which will now be described in detail. At block 312, a determination is made as to whether a metallic layered substrate or a non-metallic layered substrate is selected. This decision may rely upon many different factors, such as customer preference, cost, design considerations, etc.

If a non-metallic layered substrate is selected, the subprocess proceeds to block 316, where the graphic designer processes the artwork file by introducing silver, bronze, or gold color information to the artwork file to achieve the desired appearance. In one embodiment of the present invention, silver, gold, or bronze color information (hereinafter “metallic color”), is added or created as either a solid coverage layer or a layer comprising individual elements behind the images contained in the artwork file for visual reference. The term “behind” is used herein to mean that the metallic color layer is added as the background or base such that all other colored inks of the artwork file will overlay this layer. It will be appreciated that the metallic color layer could be solids, tones, patterns, etc. to approximate the appearance, e.g., color, texture, pattern, etc. desired by the customer. If elements are used, the metallic color elements could be contained in a single layer or in multiple layers during the design phase.

As part of the design process, the metallic color layer will be specified separately as solids or tones to create the desired appearance. The metallic ink to be used is preferably opaque and can be used to produce the metallic print effect only where desired. When printed as a non-solid, the degree of metallic effect is directly affected by the tonal amount, achieving a stronger metallic effect for higher tonal values. When printed as a solid, the opaque metallic ink will provide a fully metallic appearance. Metallic effects may be provided, for example, as an outline to highlight certain image elements printed with other colors. Alternatively, a company brand, image or promotion message might be printed with metallic ink below the color print to attract customer attention and/or further promote the company's brand. Overall, the metallic ink enables the creation of unique metallic appearing graphics within a design potentially containing non-metallic graphics.

From block 316, the subprocess proceeds to block 320, where the metallic color layer is preserved in the artwork file and designated to print as a spot color ink. In embodiments using Adobe Photoshop® as the desktop publishing program, this may be accomplished by converting the layers or elements into a spot color channel. In several embodiments of the present invention, the metallic color layer is designated within the artwork file as the first layer to be printed. As will be described below, other colored inks may be printed as solids or tones over the metallic ink layer, including white ink as will be explained in detail below, or over areas of the substrate without metallic ink. The creativity and knowledge of the graphic designer will guide this design process.

If, however, a metallic layered substrate is selected at block 312, the subprocess proceeds to block 324. The actions that occur at block 324 are substantially similar to those that occur at block 316, and thus for brevity, will not be repeated here. Since the metallic color layer that is added at block 324 is supposed to simulate the metallic layered substrate selected by the designer according to the customer's instructions, the designer creates the metallic color layer in the desktop publishing program to replicate the appearance of the selected substrate. The subprocess then proceeds to block 328, where the metallic color layer is disabled in the artwork file so that the metallic color layer will not be subsequently printed at the printing step. This step should be readily apparent since the metallic layered substrate will supply the metallic appearance to the final product. Alternatively, instead of disabling the metallic color layer, the layer may be removed or erased from the file altogether after block 344, which will be described in detail below.

It should be noted that on screen, the metallic color layer will not give a highly accurate representation of the final printed piece because the on screen RGB or CMYK colors are very different from an actual metallic layered substrate or printed metallic inks. However, the metallic color layer could help a designer envision the final appearance, although it will not be 100% accurate and will require experience on the part of the graphical designer to connect the on screen appearance to the final printed appearance.

In embodiments where a metallic layered substrate will be used, it should be apparent that the use of a solid coverage layer or metallic color elements during the design phase is optional, based on whether they are helpful toward creating the final printed result. Accordingly, if metallic color layers or elements are not included, the designer may rely on his/her experience to envision the final printed appearance from knowing the metallic substrate appearance and the graphic elements designed to overprint that substrate.

In accordance with another aspect of the present invention, the customer's instructions may dictate the desire for a product, such as a display, to have unique non-metallic graphics adjacent to metallic appearing graphics. To that end, in several embodiments of the present invention, the subprocess proceeds from either block 320 or 328 to block 332. At block 332, the graphic designer processes the artwork file to be printed by introducing white color information to the artwork file to achieve the desired appearance. For example, white color information may be added to the artwork file as a separate image layer or graphic elements. Typically, the white layer or element will be designated in the artwork file to be printed first over the metallic layer, as an opaque color using white ink. However, the white layer or elements may also be specified in other ways to achieve different effects. As will be described below, other colored inks may be printed as solids or tones over the white ink layer, over areas of the substrate without white ink, or over areas of the substrate having a metallic layer. The creativity and knowledge of the graphic designer will guide this design process.

As part of the design process, the white ink layer can be specified separately as either solids or tones to create the desired appearance. The white ink utilized by the present invention is preferably opaque and may be aqueous, solvent or UV-curable. The white ink can be used to block the metallic appearance of the metallic layer. When printed as a non-solid, the blockage is inversely affected by the tonal amount. When printed as a solid, the opaque white ink will totally block the metallic appearance. In several embodiments, the white ink may be printed by itself to provide a better “white point” than is achieved by the metallic layer. The white ink may also be provided as an outline to highlight certain image elements printed with other colors. The white ink could be used to reduce the metallic appearance of some areas, creating contrast with the metallic appearance in other areas. The white ink could also be printed as an opaque solid under other inks to improve the apparent color purity over that achieved by printing directly on the metallic layer. This capability is especially important for matching special non-metallic colors, such as those associated with a customer's brand. Overall, the white ink enables creation of unique non-metallic graphics adjacent to metallic appearing graphics.

After the white layer has been added and processed to achieve the desried design appearance, the white layer is preserved in the artwork file as a channel, such as a spot color channel if using Adobe Photoshop®, within the artwork file. As such, the channel is identified for white ink printing when the artwork file is prepared for printing, instead of being rendered by a combination of, for example, RGB inks. The white ink may be printed at the same resolution (e.g., dots per inch), or a different resolution, as the other ink colors.

The subprocess then proceeds to block 336, where the colors of the artwork file may be adjusted to achieve the desired appearance. The adjustment of color may be simply be directed to the overall image brightness or contrast, or may be as complex as adjustments to contrast, tonal value, brightness, and color balance at the color separation (e.g., C, M, Y, K) level. This step may also include adjusting the white ink layer, such as altering the placement, tonal value, etc. of the white ink layer and/or adjusting the metallic layer, such as altering the placement, tonal value, etc. of the metallic layer. Accordingly, the graphic designer uses his/her creativity and expertise to combine the metallic appearance and the white ink layer with the color image layers to achieve the desired appearance.

It will be appreciated that areas printed with tones apply color over the metallic appearance, but still allow the metallic appearance to show through, whereas where no ink is printed the appearance will be that of the metallic layer. The degree of metallic appearance will be inversely affected by the ink tonal value. For example, lower tonal values will result in a higher metallic appearance, and vice versa. Areas printed with solid coverage using transparent inks will decrease the metallic appearance, but will not eliminate it altogether. Overall, the combined effect of the metallic layer and transparent opaque inks will approximate the appearance of printing various metallic ink colors on a non-metallic surface.

It will be appreciated that the artwork file may be optionally adjusted prior to processing at block 336, or prior to conversion to another color space, if selected. These adjustments may be accomplished using the commercially available software programs mentioned above, other known or future developed software, or by other known methods.

Optionally, a clear varnish can be applied over the white inks, color inks, and/or the substrate (with or without the metallic layer) to further enhance the appearance of the product. To that end, the subprocess may proceed to block 340 where a varnish layer is generated, specified as a separated image layer within the artwork file, preserved as a channel for the digital printer, and designated to be printed as the final layer. The placement of the varnish can selectively add gloss reflectance to specific graphic elements. The differential gloss makes some elements visually more prominent and draws the viewer to them. Text and images can be subtly included or emphasized by printing them with a spot varnish. Enhanced and unique graphic designs are created through use of spot varnish with opaque white ink, transparent color inks and the metallic layer to meet the customer's desired product appearance.

A determination is then made be the graphics designer at block 344 whether or not the desired appearance as instructed by the customer has been achieved. If the desired appearance has not been achieved, the subprocess returns to block 336 for further color adjustment. If the desired appearance has been achieved, the subprocess ends at block 348.

In several illustrative examples of employing the processes described herein, an artwork file may be created in Adobe Illustrator®, processed in Adobe Photoshop® and digitally printed on a non-metallic substrate, such as paperboard, styrene, foam core, fiberboard, etc. via a XenJet 4200 ink jet printer system. The artwork file includes at least one image comprised of C, M, and Y process colors, and two spot color channels, including a metallic ink channel and a white ink channel. The image may include either a vector image and/or a raster image. The artwork file, once created and processed, includes instructions that designate the metallic ink layer to be printed first on the substrate, followed by the white ink layer, and then the colored image. In several embodiments, the metallic ink layer may cover only a portion of the substrate surface in selected locations. Similarly, in several embodiments, the white ink layer may cover a portion of the metallic ink layer and/or a portion of the substrate layer. In one embodiment, the printed artwork file may be printed in a resolution of approximately 300 dpi and in a print area of approximately 20″×12″.

One example of utilizing the digital workflow processes described herein to create a product will now be described. Once the customer's instructions are received, the original artwork file is initially prepared for conventional production using, for example, process and spot color inks. The artwork file may be opened in Adobe Illustrator®, a desktop publishing software program. Selected image elements from the existing artwork layers are copied into a new layer to be designated for white ink printing. New image elements may also be created in the white ink layer. Next, the copied image elements and new image elements may be manipulated to create the desired appearance. For instance, white ink elements may be incorporated below the brand name, selected graphics and text, and the bar code to block the metallic surface effects of the selected metallic layered substrate and provide a white background for the printed colors. In this example, other image elements are not included in the white ink layer so the metallic effect would not be blocked on the finished package.

Once the design is complete, the process color layers may be flattened into a single color layer. The artwork file, including the color and white layers, is then exported in the Photoshop® (psd) format. In this example, the export options selected include CMYK color model, other resolution (181.8 ppi), export as Photoshop® CS, write layers with maximum editability, and anti-alias. In some instances, the artwork file size may be too large to export to Photoshop format in one step. In these instances, the file is exported in two parts: the process color (CMYK) layers and the spot color (metallic, white, varnish) layers, and are later merged in Photoshop®. The psd artwork file is then opened in Adobe Photoshop®. In this example, the artwork file resolution was maintained at, for example, 181.8 dots per inch (dpi). The white ink layer is then specified as a separate white ink channel in the image. Next, the artwork file is saved as a CMYK Tagged Image File Format (TIFF) file with spot colors at a resolution of, for example, 181.8 dpi.

The saved artwork file is then sent to a Durst Rho 205 printer, available from Durst Image Technology US, Rochester, N.Y. and printed at a resolution of, for example, 363.6 dpi using a magnification factor of 2. The white ink channel is printed in underspot mode, meaning the opaque white ink was printed as the initial color on top of the metallic substrate surface layer. Other transparent process color inks are then printed on top of the metallic substrate surface or printed opaque white ink, depending on the image location. After the image has been printed on the substrate, the printed substrate is cut and creased to create the final product.

As was described above, black and white images was may utilized by the processes herein described. For example, if a true black and white image is desired, an opaque white layer would be printed first to provide a white background where required. The white ink could be printed in different amounts, for instance one application, two applications, etc. to achieve the desired opaque coverage/appearance. The white ink could also be printed as a solid or halftone dots, again for the desired appearance. Next, black ink as a spot color or a combination of C, M, Y, and K could be printed over the white areas. Black could also be printed over the silver metallic areas. When black is printed over the opaque white, a traditional black and white image is achieved. When black (or any transparent color) is printed directly over the metallic layer, the metallic layer will show through, depending on the halftone dot or solid coverage, producing a “modified” black and white image.

While opaque white ink is used in embodiments of the present invention, a transparent white ink could also be used. If a transparent white ink were printed, the metallic layer would also show through, again producing a “modified” black and white image.

Additionally, a black and metallic, for example, silver color image is also possible, eliminating the white ink altogether. The silver would provide the “white point” while the black would provide the contrast. A white and silver image is also possible, without printing black. The white ink would provide the white point and the silver would provide the contrast. Many other combinations are available, including duotone images using two process colors plus white, tritone images using three process colors plus white, etc.

Although the present invention has been described with reference to embodiments illustrated in the attached drawings, it is noted that substitutions may be made and equivalents employed herein without departing from the scope of the invention as recited in the claims. For example, although embodiments of the present invention has been described with reference to several specific editing operations that can be carried out in accordance with the present invention, embodiments of the present invention are not limited to just these operations. Rather, embodiments of the present invention can be employed with any desired editing or processing operation that a user might want to carry out to achieve the desired product appearance. Further, although examples have been described as being implemented in an exemplary embodiment with the Abode Photoshop® software package, one skilled in the art would recognize that aspects of the present invention may be implemented with other suitable desktop publishing software programs, such as Adobe PageMaker®, Adobe Illustrator®, QuarkXPress™, available from Quark, Inc. Denver Colo.; CorelDraw® and other packages available from Corel Corp., Ottawa, Ontario; or independently of such software.

The embodiments of the invention in which an exclusive property or privilege is claimed are defined as follows:

1. A method for printing an image on a substrate, the image having one or more ink layers when printed, the method comprising:
obtaining a substrate, the substrate having at least one surface on which the image will be applied;
digitally printing a white ink layer over a predetermined portion of the substrate surface; and
digitally printing one or more layers of ink over a portion of the printed white layer and/or the substrate surface, thereby generating the image on the substrate.

2. The method of claim 1, wherein at least a portion of the substrate surface includes a metallized or metallic layer, and wherein the white layer is digitally printed over at least a portion of the metallized or metallic layer.

3. The method of claim 1, further comprising
digitally printing a metallic ink layer with at least one metallic ink on the substrate surface via an ink jet printer.

4. The method of claim 1, wherein the white ink layer is digitally printed on the substrate using an ink jet printer.

5. The method of claim 1, wherein the white ink is opaque and the one or more layers of ink are transparent.

6. The method of claim 1, wherein the one or more layers of ink includes colored ink.

7. The method of claim 1, further comprising
digitally printing a layer of varnish over a portion of one of the layers of ink and/or the metallized or metallic layer.

8. The method of claim 1, wherein the substrate is selected from the group consisting of containerboard, fiberboard, linerboard, cardboard, paperboard, corrugated board, and styrene.

9. The product made from the method of claim 4.

10. A method of generating print data in a digital computer system, comprising:
generating an artwork file within an image processing program, the artwork file comprising at least one image formed by one or more inks when printed on a substrate; and
creating a white opaque ink layer as a discrete layer within the artwork file, the white ink layer designated to be printed on the substrate via an ink jet printer using white ink before the at least one image is to be printed.

11. The method of claim 10, wherein the white ink layer is preserved as a channel so that the white ink layer can be printed using white ink.

12. The method of claim 10, creating a metallic color layer as a discrete layer that simulates a metallic appearance of a substrate to which the artwork file will be printed.

13. The method of claim 10, wherein the white opaque ink layer underlays a portion of the at least one image.

14. A computer readable medium having computer-executable instructions for printing an image on a substrate, comprising:
a first component for instructing a white ink layer to be digitally printed on a surface of a substrate in select locations; and
a second component for instructing at least one other ink layer to be digitally printed on the surface of the substrate or the white ink layer, the one other ink layer creating the image on the substrate when printed.

15. The computer readable medium of claim 14, comprising
a third component for instructing a metallic ink layer to be digitally printed on the surface of the substrate prior to the white ink layer.

16. The computer readable medium of claim 15, wherein the first, second, and third components include instructions for the layers to be digitally printed by an ink jet printer.
